(19) United States
(12) Patent Application Publication
(10) Pub. No.: US 2007/0220788 A1
(43) Pub. Date: Sep. 27, 2007

(54) Personal memorial plaque

(76) Inventor: Renee Louise McCray, Baltimore, MD (US)

Correspondence Address: Mary Helen Sears;MH Sears Law Firm, Chartered, Suite 800, 910 17th St., N.W., Washington, DC, 20006, US

(21) Appl. No.: 11/389,179

(22) Filed: Mar. 27, 2006

(51) Int. Cl. G09F 19/00

(52) U.S. Cl. 40/124.5

(57) ABSTRACT

Personal memorial plaques which can be used in outdoor, as well as indoor settings, such as in a suitable holder as a marker for the grave of a deceased person or in a niche cut into a gravestone, are described. The plaques are personalized in content and may include any combination of text message, photographs or artwork, or any message, photograph or artwork alone, in any color or color combination, permanently and indelibly imprinted on a substrate such as ceramic tile, metal, translucent glass, natural stone and durable plastic or any other material with sufficient sufficient dimensional stability to be unaffected by exposure to a pressure of 40-80 psi applied evenly across the face thereof and a temperature of about 400° F. for a period between about 50 seconds and about 7.5 minutes depending upon the substrate selected. The process by which they are made is known as “sublimation”.

The present invention relates to personal memorial plaques for the commemoration of deceased family members and friends which are improved in durability, potential usefulness and overall appearance in relation to memorial plaques heretofore disclosed. These plaques can be used in the home or in any building where a memorial is desired. Alternatively, these personal memorial plaques may be used in association with a grave or a crypt or in any other desired outdoor setting.

### BACKGROUND OF THIS INVENTION

Memorial plaques of various types have heretofore been disclosed.

U.S. Pat. No. 6,557,22 describes a “casket ornament” that may be appended to the casket or cremation urn in which the remains of a deceased person (or a pet) or buried or otherwise memorialized, at least during the funeral or other memorial service for the deceased. It may then be removed and presented to the surviving family. The casket ornament may “preferably include personalized graphics” (col. 2, lines 59 et seq.) or other memorabilia of a person's life. These items are appended by push pins, screws, and/or in keyhole slots, as described in Col. 3, lines 1-42 of the cited patent, to a generally rectangular board. If one or more photographs is thus appended, it is protected by a transparent acrylic photograph cover. The board may also have attached a metal plate of, e.g. brass, on which the name of the deceased, and dates of birth and death, and like items may be engraved. The “board” to which the desired memorabilia are appended “can be made from any suitable structural material” (col. 3, lines 43-44) but “is contemplated” (Id.) to be made from furniture grade wood.

A type of a memorial plaque intended for commemoration of a deceased person or pet who has been cremated is disclosed in U.S. Pat. No. 6,665,915. The one described in this patent comprises a frame of a predetermined size and a shape corresponding to the whole or partial silhouette of the person or animal being commemorated, which frame is of a depth sufficient to enclose all or a portion of the ashes of the deceased. The frame may also enclose “indicia” such as name, birth and/or death dates, other text, graphics, designs, etc. The front side of the plaque is protected by a “generally translucent panel” which may, e.g. be glass. This plaque may be hung on a wall or attached to an urn otherwise displayed. This patent also identifies other U.S. patents disclosing various decorative commemorative panels for cremation urns and/or elements of such an urn that afford surfaces for appending, or other means for inserting commemorative panels, which may be decorated with memorabilia or other indicia of the deceased.

Other memorial plaques based, e.g., on affixing photographs and other mementos to various heavy paper and plastic substrates by mechanical means or gluing are also known in the art.

### BRIEF DESCRIPTION OF THE DRAWINGS

FIGS. 1 and 3 hereof are copies of photographs of actual memorial plaques of this invention, illustrating two of the different embodiments of the personal memorial plaque of this invention that may be made of ceramic tile.

FIG. 2 is a drawing of the side edge of a plaque in which the substrate is translucent glass.

### DESCRIPTION OF THE INVENTION

The present invention provides personal memorial plaques in which the substrate base may be of ceramic (including ceramic tile), glass, metal, wood, natural stone or any other dimensionally stable material having sufficient heat resistance to maintain its dimensional stability while being subjected to a temperature of at least 375° and up to 425° F. and pressure of 40-80 psi for a time period, both of which vary within these limits, depending upon the substrate involved. During this period, desired images in the form of original photographs, printed material, original art work or any other image deemed commemorative of the deceased are permanently and indelibly transferred to and imprinted on the surface of the substrate.

The overall general method for transferring images to a substrate base layer is described in detail in U.S. Pat. No. 6,960,384 issued Nov. 1, 2005. Preferably, memorial plaques as herein described are made from pretreated substrate base material which has been equipped with a size coat and an image receiving layer as therein described. A number of such pretreated substrate materials are available for purchase presently, in varying shapes and dimensions, at various wholesale and retail outlets.

The overall general method as described in U.S. Pat. No. 3,960,384 and as conducted using pretreated substrate bases is known as “sublimation” and is the subject of contemporary commercial catalogs circulated by suppliers of materials such as inks and heat presses and various auxiliary supplies for use in sublimation, as well as pretreated substrates. At least some supplier companies conduct courses and offer training videos which train interested persons in the techniques of sublimation and the making of representative finished products including plaques of other types. All follow the general method shown in U.S. Pat. No. 6,960,384 but temperature and pressures and times of subjection to both may vary to some extent, depending in most cases upon the particular substrate to which image transfer is to be effected.

The memorial plaques of this invention are custom-made to the order of surviving friends or relatives for whom they are created, in accordance with the specifications as to the content of each plaque that these people provide. These plaques can be created at relatively modest prices in comparison to the price levels of memorials such as granite and marble monuments erected in cemeteries, upon which engraved commemorative statements and like often appear. The plaques of this invention can provide such commemorative statements at a modest price in comparison to the cost of engraving. They can readily be made to be fitted permanently, e.g. in rectangular niches precut in such monuments or headstones to accommodate the size of the plaque. Moreover, since photographic material can readily be permanently and indelibly imprinted on these plaques, in color, the present invention presents the possibility of including one or more permanent photographic images of the deceased on a plaque that is made part of the gravestone. The photograph or photographs chosen may depict the deceased at any stage of his or her life or at a succession of stages, as desired. The possibilities in this regard are virtually endless.

Some recent third party patents, such as U.S. Pat. Nos. 5,813,642, 6,199,327, and 6,722,001 indeed recognize the desirability of associating memorial plaques of various types with, and suggest means for securing them to, existing gravestones. None of the plaques so suggested, however, is itself made of weather resistant material such as ceramic, glass, metal, durable plastic, or natural stone. In addition, no memorial plaque found has photographic material permanently and indelibly imprinted on its face.

Because of the cost involved in erecting stone and marble monuments and engraving them, suggestions have also been made for grave marker support devices designed to take their place that are designed to hold and protect a tablet-like, substantially flat and horizontally oriented commemorative plaque-type piece. An example of a fairly recent design for such a weatherproof support device appears in U.S. Pat. No. 5,845,436 granted Dec. 8, 1998. The plaques of the present invention, in association with a support device, could readily be used as grave markers, saving the family of a deceased from the much greater expense of a stone or marble monument and providing an attractive and highly personal memento of the deceased.

The versatility of, and the variations possible in, the plaques of the invention is almost limitless. They may be designed to contain memorabilia of the funeral or memorial service for the deceased such as a reproduction of an obituary or an epitaph, as well as name, dates of birth and death, a favorite prayer or psalm, advice to children or grandchildren made in written form prior to death, etc. The memorial plaque may be designed with personally held hopes and deeply held beliefs of the deceased in mind or it may be based upon the person's most admired personal qualities. It may be designed to be a memento of happy occasions in which the deceased participated or it may recall moments of special importance to a family.

Not only photographs, but original art work and/or drawings as well as written words in any desired form of lettering, including handwritten script, may be permanently imprinted on the plaques herein described. The personalized plaques of the present invention have words and pictures, words alone or pictures alone on their surfaces. The background color may be the natural color of the chosen substrate material, or it may be any other color desired by the person commissioning the plaque.

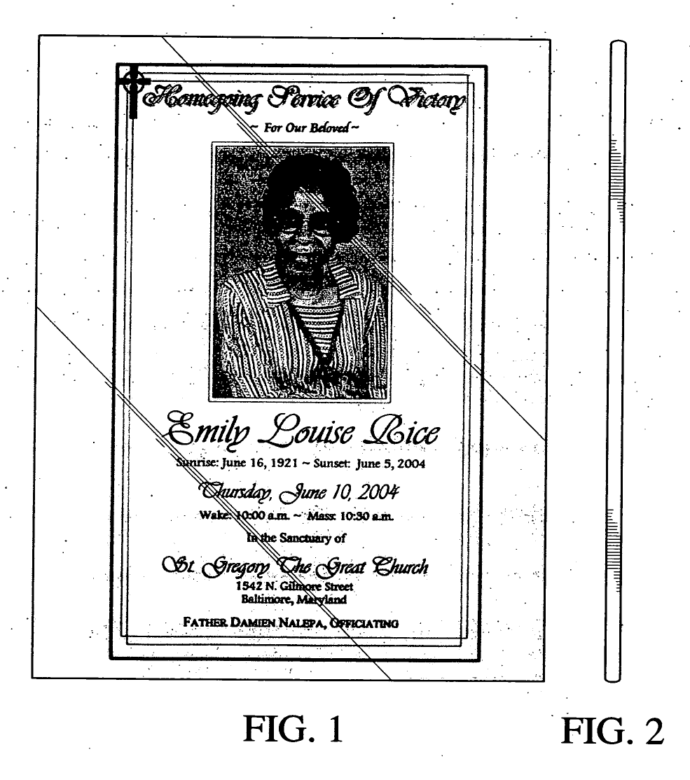

The figures hereof are pictures of finished plaques, chosen to illustrate the many options available in the finished product. Thus, FIG. 1 hereof is a photograph of a memorial plaque that includes a color photograph, the name, birth date and death date of the deceased and the particulars of her funeral service. The plaque of FIG. 1 is on ceramic tile and like all of the plaques described herein, could be displayed in the home of a relative as a picture alone might be displayed, e.g. in a decorative display device of wood or metal on a table, desk or other appropriate piece of furniture, in a frame hung on a wall, or in any other desired manner. Since the ceramic tile and other substrate materials usable in the plaques herein disclosed are very durable and the images on such substrates are permanent, the tile could also be mounted in a “memory corner” maintained by a church, a society club or other organization to which the deceased belonged, either indoors or outdoors.

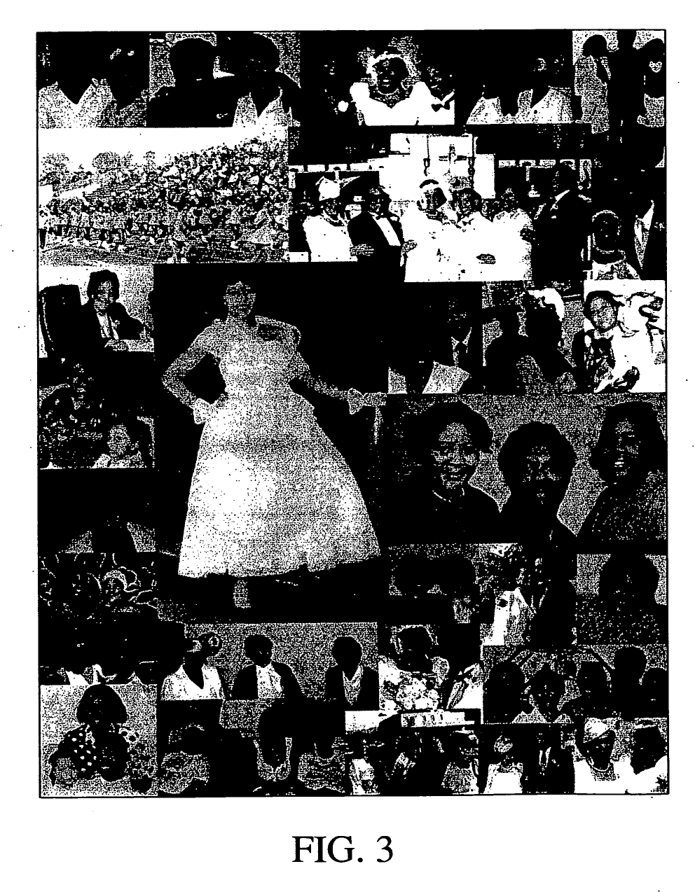

FIG. 2 hereof depicts a side view of another memorial plaque according to this invention made on translucent glass. In this embodiment only the name, birth and death dates of the deceased with the words “In loving memory” appear on the frontal view of the plaque which has a colored purple wash surrounding a photograph of the deceased, so applied that it is shaded from pale near the photograph to deeper tones of color as the wash moves outward from the photograph to the edges of the plaque. One way of displaying a plaque having a translucent glass substrate is to provide it for display purposes with a carefully located backlight which makes it the focus in whatever place it is displayed.

FIG. 3 is a collage of photographs reproduced in color on ceramic tile. The photographs were selected to show the deceased at various ages, in formal and informal settings, at home and at work. Also included are photographs of other people near and dear to her.

Any and all of the three embodiments depicted in FIGS. 1, 2 and 3 could be varied in any desired way. Normally, the process of preparing a plaque, as herein preferred to be done, entails planning a layout on paper having the same dimensions as the plaque surface to which the layout is to be transferred exactly as it is desired to appear with lettering, photographs, if any, and other embellishments, if any, placed exactly as desired and with desired colors applied. This layout may be made directly on a suitable transfer sheet or it may preliminarily be done on another sheet and then reproduced on the transfer sheet. The transfer sheet is then placed on the tile, glass, metal or other substrate material with the images to be applied facing the polymer-resin receptive layer, and heat in the range of 375-425° F., depending upon the substrate, and pressure of 40 psi which is evenly simultaneously applied across the substrate face, for a requisite time period. The substrate to which the desired image has been applied is then allowed to cool and the transfer sheet is stripped away.

In making the plaques shown in FIGS. 1-3 hereof, two of which have ceramic substrates and one a glass substrate, a temperature of 400° F. and a uniform pressure of 40 psi were applied to the substrate-transfer sheet assembly for a period of about 6.5-7.5 minutes. With other substrates, such as some plastics, applying the same heat and pressure for 65-80 seconds to the substrate-transfer assembly is adequate to achieve permanent “sublimation” or transfer of the desired image to the substrate. With metal substrates, temperature and time may both vary, depending upon the metal, but times needed, in general, are closer to 1-2 minutes.

Because the present invention can be embodied in countless combinations and permutations of surface elements, including written words and symbols, photographs, color variations, artwork or in one of these elements alone as desired, and the finished product may be displayed in a variety of outdoor and indoor areas, it is intended that the present invention will be circumscribed only by the appended claims.

I claim:

1. A memorial plaque for indoor or outdoor display that has been custom designed to commemorate a deceased person or pet having permanently and indelibly imprinted on one surface thereof an image in the form of one or more of print handwriting, photography, or artwork, all or any of which may be in any color or color combination, which plaque essentially consists of a substrate base selected from among ceramic materials including ceramic tile, glass, metal, durable plastics, natural stone or any other natural or synthetic material that is of sufficient dimensional stability to be unaffected by exposure to a pressure of 40-80 psi applied evenly across the face thereof and a temperature of about 400° F. for a period between about 50 seconds and about 7.5 minutes depending upon the substrate base selected.

2. A memorial plaque according to claim 1 having a substrate base of ceramic or ceramic tile.

3. A memorial plaque according to claim 1 having a substrate base of glass.

4. A memorial plaque according to claim 1 having a substrate base of a metal.

5. A memorial plaque according to claim 1 having a substrate base of durable plastic.

6. A memorial plaque according to claim 1 having substrate base of stone.

7. A memorial plaque according to claim 1 wherein the image permanently imprinted thereon comprises a printed or handwritten message, in any desired script or font and in any desired color or color combination plus at least one photograph in any desired color or color combination.

8. A memorial plaque according to claim 1 wherein the image indelibly and permanently imprinted thereon comprises a collage of variously colored pictures.

9. A memorial plaque according to claim 1 in which the image indelibly and permanently imprinted thereon is in the form of handwritten and printed text.

10. A memorial plaque according to claim 1 in which the substrate base is another natural or synthetic material not specifically named in claim 1.
